(19) United States
(12) Patent Application Publication
(10) Pub. No.: US 2020/0317525 A1
(43) Pub. Date: Oct. 8, 2020

(54) FLUORO-MODIFIED GRAPHENE AND PREPARATION METHOD THEREOF

(71) Applicant: SOLVAY SPECIALTY POLYMERS ITALY S.P.A., Bollate (IT)

(72) Inventors: Ivan Diego WLASSICS, Garessio (IT); Stefano MILLEFANTI, Tradate (IT); Davide VICINO, Caronno Pertusella (IT)

(73) Assignee: SOLVAY SPECIALTY POLYMERS ITALY S.P.A., Bollate (IT)

(21) Appl. No.: 16/755,080

(22) PCT Filed: Oct. 9, 2018
(86) PCT No.: PCT/EP2018/077453

§ 371 Date: Apr. 9, 2020

(30) Foreign Application Priority Data
Oct. 11, 2017 (EP) 17195849.9

(51) Int. Cl. C01B 32/194; C01B 32/198; C08F 292/00

(52) U.S. Cl. CPC C01B 32/194; C08F 292/00; C01B 32/198

(57) ABSTRACT

The present invention relates to novel fluoro-modified graphene compounds and to the processes for the preparation thereof. The invention also provides fluoro-modified graphene oxide that can be used as intermediate in the preparation of said fluoro-modified graphene compounds.

### CROSS-REFERENCE TO RELATED APPLICATIONS

This application claims priority to European application No. 17195849.9 filed on 11 Oct. 2017, the whole content of those applications being incorporated herein by reference for all purposes.

### TECHNICAL FIELD

The present invention relates to novel fluoro-modified graphene compounds and to the processes for the preparation thereof.

The invention also provides fluoro-modified graphene oxide that can be used as intermediate in the preparation of fluoro-modified graphene compounds.

### BACKGROUND ART

Graphene has attracted attention as the most promising new material due to its excellent physical and electrical properties. There have been a number of reports on methods for the production of graphene with outstanding physical properties.

Chemical functionalization of graphene has received considerable attention because it can change the chemical, structural, and electronic properties of graphene to suit specific applications.

Functionalization of graphene with heteroatoms is of fundamental importance to adjust such properties.

As an example, fluorinated graphene in which fluorine atoms are introduced in the form of C—F, C—F₂, C—F₃ onto graphene sheets through different processes known in the art has been found to exhibit a high Young's modulus, high negative magnetoresistance, and high-quality insulator properties, which makes it attractive for applications in a wide range of fields, such as lubricants, nano-composites, batteries and so on.

F-functionalization of graphene or graphene oxide wherein fluorine-containing moieties other than simple fluorine atom are linked to graphene sheets through a covalent chemical bond is also attracting interest in recent years.

Dai et al, New. J. Chem, 2015, 39, 9586-9590, describes pyrollidine-functionalized graphene containing an active pentafluorophenyl moiety sensitive to nucleophilic substitution, which can be used for the preparation of different pyrrolidine-functionalized fluorine-containing graphite.

Lee et al., Chem. Lett. 2012, 41, 76-78 discloses graphene oxide-terminated partially fluorinated poly(arylethersulfone) synthetized via aromatic nucleophilic substitution reaction. The presence of small amount of graphene oxide is reported as having an impact in improving the thermal stability of the poly(arylethersulfone).

Kim et al., Nanoscale 2014, 6, 7183-7187, discloses the preparation of fluorine-functionalized graphene oxide by reaction of graphene oxide with 4-(trifluoromethyl)phenylhydrazine and its use as interfacial material in photovoltaic cells having improved efficiency and stability.

Fluorinated graphene is a promising material also for use in rechargeable batteries and in supercapacitors.

As an example, CN105680005 describes a composite material comprising a polymeric material containing graphene and graphene grafted with fluorinated sulfonamide groups which demonstrates an excellent positive ion conductivity and excellent electron conductivity and can improve the electrochemical performances of the charging/discharging process in batteries.

There is still the need in the art for new fluoro-modified graphene derivatives endowed with enhanced novel electrochemical/physical properties that could highly enhance utilization and performances of graphene to make them suitable for use in various applications.

### SUMMARY OF INVENTION

The present invention thus provides, in a first object, a fluorinated graphene derivative [fluorinated graphene (FG)] comprising:
a graphene having a plurality of inner and peripheral carbon atoms; and
at least one fluorinated moiety (R), wherein said fluorinated moiety (R) is selected from the group consisting of fluorinated alkyl, fluorinated heteroalkyl, fluorinated aryl or a fluorinated polymeric or oligomeric moiety; wherein the at least one fluorinated moiety (R) is covalently bound to at least one internal or peripheral carbon atom of the graphene via a linking group (L),

wherein said linking group (L) is a bond or is selected from the group consisting of *—O—**, *—O—C(O)—** and *—C(O)—O—**, wherein the symbol * indicates the bond with graphene and the symbol** indicates the bond with the fluorinated moiety (R).

The present invention further provides at least one preparation method for preparing the fluorinated graphene derivatives (FG) as above defined, said methods comprising covalently coupling a fluorinated compound (FC) to a carbon atom of graphene through reaction of at least one functional group of the FC with at least one inner or peripheral carbon atom of graphene or graphene oxide.

In one further object, the present invention thus pertains to a method for manufacturing the fluorinated graphene derivatives (FG) as above detailed, said method comprising:

(i) providing a graphene having a plurality of inner and peripheral carbon atoms;
(ii) reacting at least one inner or peripheral carbon atom of the graphene provided in step (i) with at least one fluorinated compound (FC) of formula R—X,
wherein R is a fluorinated moiety selected from the group consisting of fluorinated alkyl, fluorinated heteroalkyl, fluorinated aryl or a fluorinated polymeric or oligomeric moiety, and X is a halogen atom.

In a further object, the present invention pertains to another method for manufacturing the fluorinated graphene derivatives (FG) as above detailed, said method comprising:

(a) providing a graphene oxide having a plurality of inner and peripheral carbon atoms wherein at least one inner or peripheral carbon atom bears an oxygen-containing reactive group, such as hydroxyl group, epoxide group, carboxyl group or ketone group;
(b) reacting at least one inner or peripheral carbon atom bearing an oxygen-containing reactive group of the graphene oxide provided in step a. with at least one fluorinated compound (FC) of formula R—X′ to obtain a fluorinated graphene oxide (FGO),
wherein R is a fluorinated moiety selected from the group consisting of fluorinated alkyl, fluorinated heteroalkyl, fluorinated aryl or a fluorinated polymeric or oligomeric moiety, and X′ is a group selected from a hydroxyl group, an alcoxide group, a magnesium halide group MgHaI, wherein Hal denotes a halogen atom, a sulfonated ester group or an acyl halide group; and
(c) reducing residual oxygen-containing reactive groups of the graphene oxide.

The intermediate compounds formed in step (b) [fluorinated graphene oxide derivatives (FGO)] are novel and represent a further aspect of the present invention.

In a further object, thus, the invention provides novel fluorinated graphene oxide derivatives (FGO) that can be used as intermediates in the process for preparing the fluorinated graphene derivatives (FG) as above detailed.

### BRIEF DESCRIPTION OF DRAWINGS

FIG. 1 is a schematic drawing showing the structure of a graphene layer.

FIG. 2 s a schematic drawing showing the structure of a graphene oxide layer.

### DESCRIPTION OF EMBODIMENTS

In the context of the present invention, the use of parentheses “( . . . )” before and after symbols or numbers identifying formulae or parts of formulae has the mere purpose of better distinguishing that symbol or number with respect to the rest of the text; thus, said parentheses could also be omitted.

The present invention provides new fluorinated graphene derivatives (FG) wherein at least one fluorinated moiety is covalently bound to at least one inner or peripheral carbon atom of the graphene.

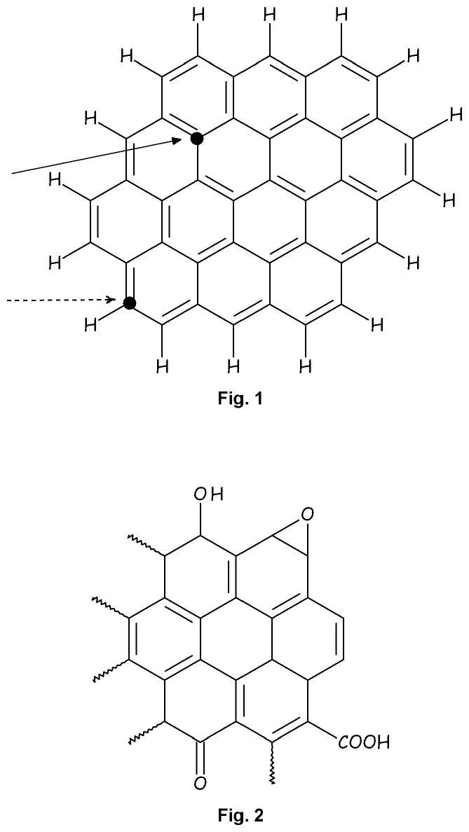

The term “graphene” as used herein refers to a polycyclic aromatic molecule formed from a plurality of carbon atoms which are covalently bound to each other, as shown in FIG. 1.

The covalently bound carbon atoms may form a six-membered ring as a repeating unit, and may further include at least one of a five-membered ring and a seven-membered ring. Accordingly, graphene comprises a single layer of covalently bonded carbon atoms having sp² hybridization belonging to fused rings. A plurality of graphene layers is often referred to in the art as graphite. However, for convenience, “graphene” as used herein may be a single layer, or also may comprise a plurality of layers of carbon.

Thus graphene, as used herein, may have a multiply layered structure formed by stacking single layers of graphene.

Graphene, as used herein, has a plurality of inner and peripheral carbon atoms.

For the purpose of the invention, by the term “inner carbon atom” it is intended to denote a carbon atom which is bound to three other carbon atoms and belongs to a ring in the polycyclic aromatic molecule which is fused with six other rings, as shown in FIG. 1 with a solid line arrow.

For the purpose of the invention, by the term “peripheral carbon atom” it is intended to denote a carbon atom belonging to a ring on the lateral portion of a graphene layer, as shown in FIG. 1 with a dashed line arrow.

As used herein, the term “fluorinated alkyl” refers to a linear, branched or cyclic hydrocarbon chain in which some or all of the hydrogen atoms are replaced with fluorine atoms.

The term “fluorinated heteroalkyl” refers to a fluorinated alkyl group in which one or more carbon atoms are replaced by heteroatom(s) such as O or S, preferably O.

In the context of the present application, the term “fluorinated alkyl” or “fluorinated heteroalkyl” may include fluorinated alkyl or fluorinated heteroalkyl that are optionally substituted with halogen or hydroxyl groups or that are optionally unsaturated.

The term “fluorinated aryl” refers to a radical derived from an aromatic system having 6 to 18 carbon atoms including, but not limited to, phenyl, biphenyl, naphthyl, anthracenyl and the like, in which some or all of the hydrogen atoms are replaced with one or more of the following: a fluorine atom, a fluorinated linear or branched alkyl, a fluorinated linear or branched heteroalkyl.

In the context of the present application, the term “fluorinated aryl” may include fluorinated aryl optionally substituted with halogen, alkyl, alkenyl, alkynyl, aryl, ether, thioether, carboxylic acid, ester, amide, amine, imide.

Preferably, the fluorinated aryl is a phenyl radical wherein at least one hydrogen atom of the benzene ring is substituted with a fluorine atom, more preferably wherein all the five hydrogen atoms are substituted with five fluorine atoms.

The term “linking group” refers to a moiety connecting a fluorinated moiety R to an inner or peripheral carbon atom of graphene.

In a preferred embodiment, the at least one fluorinated moiety (R) is a C₄-C₁₀ fluorinated alkyl and the linking group (L) is a bond, *—O—**, *—O—C(O)—** or *—C(O)—O—**, wherein the meaning of the symbols * and ** is as above defined.

Particularly suitable fluorinated alkyl moieties according to this embodiment have formula (CF₃)₃C—, C₆F₁₃—, C₆F₁₃(CH₂)₂— or C₄F₉(CH₂)₂—.

According to another preferred embodiment, the at least one fluorinated moiety (R) is a fluorinated aryl, more preferably a fully fluorinated phenyl, and the linking group (L) is a bond.

According to another preferred embodiment, the at least one fluorinated moiety (R) is a fluorinated polymeric or oligomeric moiety, and the linking group (L) is a bond, *—O—** or *—O—C(O)—**,

wherein the meaning of the symbols * and ** is as above defined.

For the purpose of the present invention, the term “fluorinated polymeric or oligomeric moiety” is intended to denote polymers and oligomers comprising recurring units deriving from the polymerization of at least one ethylenically unsaturated fluorinated monomer as well as fluorinated polyethers.

Non limiting examples of suitable ethylenically unsaturated fluorinated monomers are:
C₂-C₈ fluoro- and/or perfluoroolefins such as tetrafluoroethylene (TFE), hexafluoropropylene (HFP), pentafluoropropylene and hexafluoroisobutylene;
C₂-C₈ hydrogenated fluoroolefins, such as vinyl fluoride, 1,2-difluoroethylene, vinylidene fluoride (VDF) and trifluoroethylene;
perfluoroalkylethylenes of formula CH₂═CH—R_{f0}, wherein R_{f0} is a C₁-C₆ perfluoroalkyl group;
chloro- and/or bromo- and/or iodo-C₂-C₆ fluoroolefins such as chlorotrifluoroethylene (CTFE);
(per)fluoroalkylvinylethers of formula CF₂═CFOR_{f1}, wherein R_{f1} is a C₁-C₆ fluoro- or perfluoroalkyl group, e.g. —CF₃, —C₂F₅, —C₃F₇, such as perfluoromethylvinylether (MVE);
(per)fluoro-oxyalkylvinylethers of formula CF₂═CFOX₀, wherein X₀ is a C₁-C₁₂ oxyalkyl group or a C₁-C₁₂ (per)fluorooxyalkyl group having one or more ether groups, e.g. perfluoro-2-propoxy-propyl group;
fluoroalkyl-methoxy-vinylethers of formula CF₂═CFOCF₂OR_{f2}, wherein R_{f2} is a C₁-C₆ fluoro- or perfluoroalkyl group, e.g. —CF₃ (MOVE3), —C₂F₅, —C₃F₇ or a C₁-C₆ (per)fluorooxyalkyl group having one or more ether groups, e.g. —C₂F₅—O—CF₃;
fluorodioxoles of formula:

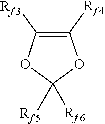

wherein each of R_{f3}, R_{f4}, R_{f5} and R_{f6}, equal to or different from each other, is independently a fluorine atom, a C₁-C₆ fluoro- or per(halo)fluoroalkyl group, optionally comprising one or more oxygen atoms, e.g. —CF₃, —C₂F₅, —C₃F₇, —OCF₃, —OCF₂CF₂OCF₃.

In one embodiment fluorinated polymeric or oligomeric moieties are those comprising recurring units derived from at least one ethylenically unsaturated fluorinated monomer and recurring units derived from at least one hydrophilic (meth)acrylic monomer (MA) of formula (I):

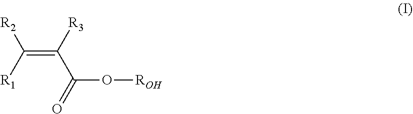

wherein each of R₁, R₂, R₃, equal or different from each other, is independently an hydrogen atom or a C₁-C₃ hydrocarbon group, and R_{OH} is a hydroxyl group or a C₁-C₅ hydrocarbon moiety comprising at least one hydroxyl group.

The term “at least one hydrophilic (meth)acrylic monomer (MA)” is understood to mean that the fluorinated polymeric or oligomeric moiety may comprise recurring units derived from one or more than one hydrophilic (meth)acrylic monomer (MA) as above described. In the rest of the text, the expressions “hydrophilic (meth)acrylic monomer (MA)“and” monomer (MA)” are understood, for the purposes of the present invention, both in the plural and the singular, that is to say that they denote both one or more than one hydrophilic (meth)acrylic monomer (MA).

According to certain embodiments, the fluorinated polymeric or oligomeric moiety is a partially fluorinated fluoropolymer comprising, preferably consisting of, recurring units derived from VDF and recurring units deriving from a hydrophilic (meth)acrylic monomer (MA) of formula (I), as above defined, wherein R_{OH} is a C₁-C₅ hydrocarbon moiety comprising at least one hydroxyl group.

In another embodiment of the present invention, the fluorinated polymeric moieties are fluorinated polyethers comprising at least one (per)fluoropolyether (PFPE) chain [chain (R_{pf})].

Preferably, said chain (R_{pf}) is a chain of formula —(CFX₁)ₐO(R_{f})(CFX₂)_{b}—, wherein

a and b, equal or different from each other, are equal to or higher than 1, preferably from 1 to 10, more preferably from 1 to 3;
X₁ and X₂, equal or different from each other, are —F or —CF₃, provided that when a and/or b are higher than 1, X₁ and X₂′ are —F;
(R_{f}) comprises, preferably consists of, repeating units being independently selected from the group consisting of:
(i) —CF X₁O—, wherein X₁ is F or CF₃;
(ii) —CF X₁CF X₁O—, wherein X₁, equal or different at each occurrence, is F or CF₃, with the proviso that at least one of X₁ is —F;
(iii) —CF₂CF₂CW₂O—, wherein each of W, equal or different from each other, are F, C₁, H;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CF X₁O—, —CF₂CF X₁O—, —CF₂CF₂CF₂O—, —CF₂CF₂CF₂CF₂O—, with each of each of X₁ being independently F or CF₃ and T being a C₁-C₃ perfluoroalkyl group.

More preferably, a and b, equal or different from each other, are from 1 to 10, even more preferably from 1 to 3.

Preferably, chain (R_{f}) complies with the following formula:

—[(CFX¹O)_{g1}(CFX²CFX³O)_{g2}(CF₂CF₂CF₂O)_{g3}(CF₂CF₂CF₂CF₂O)_{g4}]— (R_{f}-I)

wherein
X¹ is independently selected from —F and —CF₃,
X², X³, equal or different from each other and at each occurrence, are independently —F, —CF₃, with the proviso that at least one of X is —F;
g1, g2, g3, and g4, equal or different from each other, are independently integers ≥0, such that g1+g2+g3+g4 is in the range from 2 to 300, preferably from 2 to 100; should at least two of g1, g2, g3 and g4 be different from zero, the different recurring units are generally statistically distributed along the chain.

More preferably, chain (R_{f}) is selected from chains of formula:

—[(CF₂CF₂O)ₐ₁(CF₂O)ₐ₂]— (R_{f}—IIA)

wherein:
a1 and a2 are independently integers ≥0 such that the number average molecular weight is between 400 and 10,000, preferably between 400 and 5,000; both a1 and a2 are preferably different from zero, with the ratio a1/a2 being preferably comprised between 0.1 and 10;

—[(CF₂CF₂O)_{b1}(CF₂O)_{b2}(CF(CF₃)O)_{b3}d(CF₂CF(CF₃)O)_{b4}]— (R_{f}-IIB)

wherein:
b1, b2, b3, b4, are independently integers ≥0 such that the number average molecular weight is between 400 and 10,000, preferably between 400 and 5,000; preferably b1 is 0, b2, b3, b4 are >0, with the ratio b4/(b2+b3) being ≥1;

—[(CF₂CF₂O)_{c1}(CF₂O)_{c2}(CF₂(CF₂)_{cw}CF₂O)_{c3}]— (R_{f}-IIC)

wherein:
cw=1 or 2;
c1, c2, and c3 are independently integers 0 chosen so that the number average molecular weight is between 400 and 10,000, preferably between 400 and 5,000; preferably c1, c2 and c3 are all >0, with the ratio c3/(c1+c2) being generally lower than 0.2;

—[(CF₂CF(CF₃)O)_{d}]— (R_{f}-IID)

wherein:
d is an integer >0 such that the number average molecular weight is between 400 and 10,000, preferably between 400 and 5,000;

—[(CF₂CF₂C(Hal*)₂O)ₑ₁—(CF₂CF₂CH₂O)ₑ₂—(CF₂CF₂CH(Hal*)O)ₑ₃]— (R_{f}-IIE)

wherein:
Hal*, equal or different at each occurrence, is a halogen selected from fluorine and chlorine atoms, preferably a fluorine atom;
e1, e2, and e3, equal to or different from each other, are independently integers ≥0 such that the (e1+e2+e3) sum is comprised between 2 and 300.

Still more preferably, chain (R_{f}) complies with formula (R_{f}-III) here below:

—[(CF₂CF₂O)ₐ₁(CF₂O)ₐ₂]— (R_{f}-III)

wherein:
a1, and a2 are integers >0 such that the number average molecular weight is between 400 and 10,000, preferably between 400 and 5,000, with the ratio a1/a2 being generally comprised between 0.1 and 10, more preferably between 0.2 and 5.

The fluorinated graphene (FG) according to the present invention comprises at least one fluorinated moiety (R) bound to at least one inner or peripheral carbon atom of a single layer graphene or a plurality of graphene layers. Preferably, the at least one fluorinated moiety (R) is bound to a graphene single layer.

The fluorinated graphene (FG) of the present invention comprises a percentage amount of the at least one fluorinated moiety (R) covalently bound to graphene ranging from 1% to 85% by weight, with respect to the weight of graphene. Covalent binding of the fluorinated moiety (R) to graphene can be verified and quantified by ¹³C-NMR, ¹⁹F-NMR and ¹H-NMR, in solution as well as in solid state NMR, through a method that comprises analysing the reaction medium and optional washings after the fluorinated graphene in solid form has been separated and recovered.

More than one fluorinated moiety can be connected to one or more inner or peripheral carbon atoms of a single layer graphene or of a plurality of graphene layers, and through different linking groups, depending upon the specific fluorinated moieties R, the molar ratios between the graphene and the fluorinated moiety and preparation processes, as can readily be determined by one of skilled in the art.

In a second object, the present invention pertains to a method for manufacturing the fluorinated graphene derivatives (FG) as above detailed, said method comprising:

(i) providing a graphene having a plurality of inner and peripheral carbon atoms;
(ii) reacting at least one inner or peripheral carbon atom of the graphene provided in step (i) with at least one fluorinated compound (FC) of formula R—X,
wherein R is a fluorinated moiety (R) selected from the group consisting of fluorinated alkyl, fluorinated heteroalkyl, fluorinated aryl or a fluorinated polymeric or oligomeric moiety, and X is a halogen atom.

Graphene provided in step (i) of the method can be purchased from a commercial source. Various kinds of graphene oxides are commercially available e.g. from ACS as Directa+ and from Angstron Materials as Graphitene.

Alternatively, graphene can be obtained by reducing graphene oxide by a thermal treatment at a temperature of at least 200° C., preferably at least 230° C., more preferably about 240° C. for a time ranging from 10 to 60 minutes.

In preferred embodiments according to this object, the fluorinated compound (FC) is a compound of formula R—X, wherein
R is as above defined and
X is an iodine atom.

Particularly suitable fluorinated compounds (FC) according to this preferred embodiment are selected from compounds of formula R—X wherein:
R is a C₄-C₁₀ fluorinated alkyl, more preferably it is C₆F₁₃(CH₂)₂—, C₆F₁₃—, C₄F₉(CH₂)₂— or I—C₆F₁₂—;
R is a fluorinated aryl, such as a partially or fully fluorinated phenyl, more preferably R is C₆F₅—;
R is a fluorinated polymeric or oligomeric moiety selected from:
a partially fluorinated fluoropolymer comprising recurring units deriving from the polymerization of at least one, more preferably two or three, ethylenically unsaturated fluorinated monomer preferably selected from the group consisting of VDF, TFE, MVE and HFP; or
a fluorinated polyether comprising at least one (per)fluoropolyether (PFPE) chain [chain (R_{pf})] as above defined;
   and X is an iodine atom.

In a particularly preferred embodiment, the fluorinated compound (FC) is a fluorinated polyether comprising perfluoropolyether (PFPE) chain (R_{pf}) of formula —(CF X₁)ₐO(R_{f})(CF X₂)_{b}— and having two chain ends, wherein at least one of said chain ends bears one iodine atom.

Preferred PFPEs bearing an iodine chain end are described for example in EP1256562.

The reaction of step (ii) includes the homolytic cleavage of the R—X bond that leads to a radical fluorinated moiety which then reacts with at least one inner or peripheral carbon atom of graphene to form a covalent bond between said carbon atom and the fluorinated moiety.

The hemolytic cleavage can be carried out by a thermal treatment (thermal homolytic cleavage) or in the presence of a chain initiator, such a benzoyl peroxide (BPO), di-tert-butyl peroxide (DTBP) and 2,2′-azo-bis-isobutyrylnitrile (AIBN) (redox-activated homolytic cleavage).

Thermal homolytic cleavage may suitably be carried out by heating the fluorinated compound (FC) to a temperature in the range comprised between 150 and 300° C., preferably between 200 and 270° C.

The reaction of step (ii) can be carried out in the presence of a solvent.

Suitable solvents for reaction step (ii) are fully fluorinated solvents such as perfuoroalkanes, perfluoropolyethers and tertiary perfluorinated amines.

Suitably, the equivalent ratio between graphene and fluorinated compound in step (ii) is comprised between 1 and 350.

The reaction step (ii) typically results in a weight percentage of covalently bound fluorinated moiety to graphene comprised between 12% and 80% by weight with respect to the starting amount of graphene.

Fluorinated graphene derivatives (FG) in the form of powder are typically obtained at the end of step (ii).

In a third object, the present invention pertains to another method for manufacturing the fluorinated graphene derivatives (FG) as above detailed, said method comprising:

(a) providing a graphene oxide having a plurality of inner and peripheral carbon atoms wherein at least one peripheral carbon atom bears an oxygen-containing reactive group such as hydroxyl group, epoxide group, carboxyl group or ketone group;
(b) reacting at least one peripheral carbon atom bearing an oxygen-containing reactive group of the graphene oxide provided in step (a) with at least one fluorinated compound (FC) of formula R—X′ to obtain a fluorinated graphene oxide (FGO),
wherein R is a fluorinated moiety (R) selected from the group consisting of fluorinated alkyl, fluorinated heteroalkyl, fluorinated aryl or a fluorinated polymeric or oligomeric moiety, and X′ is a group selected from a hydroxyl group, an alcoxide group, a magnesium halide group MgHal, wherein Hal denotes a halogen atom, a sulfonated ester group or an acyl halide group; and
(c) reducing residual oxygen-containing reactive groups of the graphene oxide.

By the term “graphene oxide” it is meant any oxidized form of graphene wherein oxygen-containing reactive groups such as carbonyl groups, epoxy groups, hydroxyl groups, carboxyl group and double bonds may be introduced into a graphene, either a graphene single layer or a multiple layered graphene.

By the term “oxygen-containing reactive group” it is meant a group able to react with fluorinated compounds (FC) as above defined through ionic mechanisms of reaction.

Normally, graphene oxide can be prepared by the so called Hummers method, which comprises: placing graphite, potassium permanganate and concentrated strong oxidizing acid (sulfuric acid or nitric acid) into the same container for heating by water-bath or oil-bath, then taking out, reducing potassium permanganate with hydrogen peroxide firstly, then washing the products with distilled water or hydrochloric acid for many times, drying to obtain graphite oxide.

In order to prepare graphene oxide, Hummers method can be improved.

In a further aspect, the present invention provides an improved preparation method comprising:
adding graphite, potassium persulfate and phosphorus pentoxide in mass ratio of 2:1:1 into concentrated sulfuric acid at 60/85° C.; stirring well, and then cooling naturally, washing to neutrality, and drying to obtain pretreated mixture; and
adding said pretreated mixture and potassium permanganate into concentrated sulfuric acid, keeping the temperature below 20° C., then heating in an oil-bath at 30/40° C. for 1.5/2.5 h, adding deionized water, after 15 minutes, adding hydrogen peroxide to react, filtering by applying pressure, collecting solid; and
washing the solid with diluted hydrochloric acid, drying to obtain graphene oxide.

In FIG. 2 an example of the structure of a portion of a graphene oxide single layer obtained by oxidizing graphene as above described is shown. Oxygen-containing reactive group such as carbonyl groups, epoxy groups, hydroxyl groups and carboxyl groups can be present on peripheral carbon atoms of the graphene structure, and oxygen-containing reactive group such as epoxy groups, non-aromatic double bonds and hydroxyl groups can be present on inner carbon atoms.

Alternatively, graphene oxide can be purchased from a commercial source. Various kinds of graphene oxides are commercially available e.g. from Angstron Materials, from Graphitene and from ACS.

The oxygen content of a graphene oxide may be equal to or greater than about 1 wt %, for example, equal to or greater than about 3 wt %, or equal to or greater than about 5 wt % and less than about 30 wt %, for example, equal to or less than about 15 wt %, or equal to or less than about 10 wt %.

In preferred embodiments according to this third object, the fluorinated compound (FC) is a compound of formula R—X′ wherein
R is a fluorinated moiety selected from the group consisting of fluorinated alkyl, fluorinated heteroalkyl, fluorinated aryl and fluorinated polymeric or oligomeric moiety; and
X′ is a hydroxyl group, an alcoxide group, a magnesium halide group MgHal, wherein Hal denotes a halogen atom, a sulfonated ester group or an acyl halide group.

Suitably, the sulfonated ester group is tosylate, besylate, brosylate, nosylate, mesylate, tresylate, nonaflate or triflate.

Particularly suitable fluorinated compounds (FC) according to this preferred embodiment are selected from compounds of formula R—X′ wherein:
R is a C₄-C₁₀ fluorinated alky, more preferably it is C₆F₁₃(CH₂)₂— or C₄F₉(CH₂)₂—;
R is a fluorinated aryl, such as a partially or fully fluorinated phenyl, more preferably R is C₆F₅—;
   and
   X′ is a hydroxyl group, an alcoxide group, a magnesium halide group MgHal, wherein Hal denotes a halogen atom, a sulfonated ester group or an acyl halide group.

In a further preferred embodiment, suitable fluorinated compounds (FC) according to this preferred embodiment are selected from compounds of formula R—X′ wherein:
R is a fluorinated polymeric or oligomeric moiety selected from:
a partially fluorinated fluoropolymer comprising recurring units deriving from the polymerization of at least one, more preferably two or three, ethylenically unsaturated fluorinated monomer preferably selected from the group consisting of VDF, TFE, MVE and HFP; or
a fluorinated polyether comprising at least one (per)fluoropolyether (PFPE) chain [chain (R_{pf})] as above defined;
   and
   X′ is a hydroxyl group, an alcoxide group, a sulfonated ester group or an acyl halide group.

According to this preferred embodiment, X′ can be linked to the fluorinated polymeric or oligomeric moiety at one terminal, thus representing at least one chain end of said fluorinated polymeric or oligomeric moiety or it can be a pendant group belonging to at least one recurring unit in the fluorinated polymeric or oligomeric moiety.

According to this embodiment, the fluorinated compound (FC) is preferably a partially fluorinated fluoropolymer comprising recurring units deriving from the polymerization VDF comprising at least one hydrophilic (meth)acrylic monomer (MA) of formula (I):

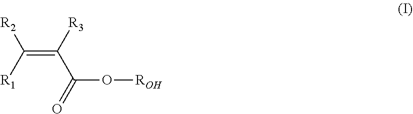

wherein each of R₁, R₂, R₃, equal or different from each other. is independently an hydrogen atom or a C₁-C₃ hydrocarbon group, and R_{OH} is a hydroxyl group or a C₁-C₅ hydrocarbon moiety comprising at least one hydroxyl group.

In a particularly preferred embodiment, the fluorinated compound (FC) is a (per)fluoropolyether (PFPE) comprising perfluoropolyether chain (R_{pf}) of formula —(CF X₁)ₐO(R_{f})(CF X₂)_{b}— and having two chain ends, wherein at least one of said chain ends bears at least one group selected from a hydroxyl (PFPE alcohol) or a sulfonated ester group.

Preferred PFPE alcohols are those of formula HOCH₂—(CFX₁)ₐO(R_{f})(CFX₂)_{b}— CH₂OH, wherein chain (R_{f}) complies with formula (R_{f}-I) here below:

—[(CF₂CF₂O)ₐ₁(CF₂O)ₐ₂]— (R_{f}-I)

wherein:
a, b, a1, and a2 are integers >0 such that the number average molecular weight is between 400 and 10,000, preferably between 400 and 5,000, with the ratio a1/a2 being generally comprised between 0.1 and 10, more preferably between 0.2 and 5.

Preferred PFPE alcohols defined above can be manufactured by chemical reduction of corresponding PFPE carboxylic acids or esters according to several methods known in the art, using reducing agents such as NaBH₄, or by catalytic hydrogenation, as disclosed, for example, in U.S. Pat. No. 6,509,509 AUSIMONT SPA 20010705. Precursors of PFPE carboxylic acids or of PFPE esters can be manufactured according to different methods, e.g. by oxypolymerization of fluoroolefins or by ring opening polymerization of HFPO (hexafluoropropylene oxide), as taught in U.S. Pat. No. 7,132,574 SOLVAY SOLEXIS SPA 20061107.

The reaction conditions utilized in step (b) of the method of the present invention are dependent upon the nature of the fluorinated compound, as can readily be determined by one of skill in the art.

By reaction step (b), fluorinated graphene oxide derivatives (FGO) wherein at least 25% of the oxygen containing groups of the graphene oxide have been covalently functionalized with at least one fluorinated moiety R can be obtained.

In preferred embodiments, in reaction step (b), at most 50% of the oxygen containing groups of the graphene oxide are covalently functionalized with a at least one fluorinated moiety (R) to obtain fluorinated graphene oxide derivatives (FGO).

At the end of reaction step (b), the fluorinated graphene oxide derivatives (FGO) thus obtained may include unreacted residual oxygen-containing reactive groups which can be thermally reduced to obtain the fluorinated graphene derivatives (FG) of the invention, in this way regaining aromaticity of the graphene structure

Reaction step (c) can be carried out by thermally treating the FGO obtained in step (b) in the presence of a solvent at a temperature ranging from 50 to 250° C., under stirring.

Reaction step (c) may also be carried out by submitting FGO obtained in step (b) to mild ultrasound treatment.

Suitably, the ultrasound treatment can be carried out at a temperature comprised between 40 and 50° C. with a frequency comprised between 60 and 90 kHz. Reaction step (c) can be carried out directly on the suspension obtained at the end of step (b) or, alternatively, after isolating and re-suspending the obtained FGO in a suitable solvent.

Suitable solvents for step (c) are THF, C₆F₆ and perfluoropolyethers.

The fluorinated graphene oxide derivatives (FGO) formed in step (b) by reaction of at least one oxygen-containing group of a graphene oxide with at least one compound of formula R—X′, wherein R and X′ are as above defined, are novel and represent a further aspect of the present invention.

In a further object, thus, the invention provides fluorinated graphene oxide derivatives (FGO) comprising:
a graphene oxide having a plurality of inner and peripheral carbon atoms; and
at least one fluorinated moiety (R), wherein said fluorinated moiety (R) is selected from the group consisting of fluorinated alkyl, fluorinated heteroalkyl, fluorinated aryl or a fluorinated polymeric or oligomeric moiety; wherein the at least one fluorinated moiety (R) is covalently bound to at least one peripheral carbon atom of the graphene oxide via a linking group (L),
   wherein said linking group (L) is a bond or is selected from the group consisting of *—O—**, *—O—C(O)—** and *—C(O)—O—**,
   wherein the symbol * indicates the bond with graphene and the symbol** indicates the bond with the fluorinated moiety (R),
   wherein the fluorinated polymeric or oligomeric moiety comprises recurring units deriving from the polymerization of at least one ethylenically unsaturated fluorinated monomer or is a fluorinated polyether comprising at least one (per)fluoropolyether (PFPE) chain [chain (R_{pf})].

The fluorinated graphene oxide derivatives (FGO) as above defined can be used as intermediates in the process for preparing the fluorinated graphene derivatives (FG) as above detailed.

Graphene modification with fluorinated moieties such as fluorinated alkyl, fluorinated heteroalkyl, fluorinated aryl and fluorinated polymer or oligomers as above defined could highly enhance utilization and performances of this material due to enhanced electrochemical/physical properties, enhanced chemical resistance and enhanced barrier membrane properties.

Therefore, the fluorinated graphene derivatives (FG) of the present invention can be suitably used in supercapacitors, for example as electrode binders, and as fillers and additives in fluoropolymers with the aim of improving the mechanical properties thanks to the compatibilizing effect due to the content of fluorine in the compounds.

Should the disclosure of any patents, patent applications, and publications which are incorporated herein by reference conflict with the description of the present application to the extent that it may render a term unclear, the present description shall take precedence.

The invention will be now described with reference to the following examples, whose purpose is merely illustrative and not intended to limit the scope of the invention.

### EXPERIMENTAL PART

### Raw Materials

Graphene, commercially available as Pure G+ from Directa Plus. Graphene oxide (GO), commercially available from Graphitene. Z-DOL-PFPE=a PFPE alcohol complying with formula HO—H₂CF₂—(CF₂CF₂O)ₐ₁(CF₂O)ₐ₂—CF₂CH₂—OH, commercially available as Fomblin® Z-DOL from Solvay.

PVDF-HEA=VDF copolymer comprising 0.85 wt %, 0.7 mol %, EW=9383 g/eq, of hydroxyethyalcrylate (HEA).
TFE-MVE-(CF₂I)₂=TFE copolymer comprising 14% moles of MVE and having —CF₂I iodinated end groups.

### Methods

¹H-NMR analyses were performed on a Varian Mercury 300 MHz spectrometer using tetramethylsilane (TMS) as internal standard.

¹⁹F-NMR analyses were performed on a Varian Mercury 300 MHz spectrometer using CFCl₃ as internal standard.

¹³C—(H)CP MAS analyses were performed on a Varian 500 MHz spectrometer.

The formation of fluorinated graphene was confirmed by ¹³C—(H)CP MAS solid state NMR, ¹⁹F pulse MAS solid state NMR and ¹H solid state NMR.

### Resistivity Measurement

Resistivity ρᵥ was calculated on casts of fluorinated graphene and of fluorinated graphene oxide by the following formula and has units of Ω*cm (Ohm*cm):

ρᵥ=(Ω*W*t)/L

where:
Ω=resistance measured (Ohm)
W=width (cm) of the electrode
t=thickness (cm) of the cast fluorinated graphene
L=distance (cm) between the 2 electrodes used for the measurement.

Casts of fluorinated graphene and fluorinated graphene oxide were obtained starting from suspensions in THF (10% w/w) of the same; the stable suspensions were filtered in a pressure filter directly upon a PTFE membrane. Very uniform casts were obtained for resistivity measurements.

### Contact Angle Vs Water

The static contact angle towards water MilliQ at 20° C. was evaluated by using the OCA-20 Data-Physics Instrument, according to ASTM D 2578-84, D 5725-99.

When the measured contact angle is >85° the sample is hydrophobic, while when the contact angle is <85° the sample is hydrophilic.

### Example 1—Synthesis of Graphene-CF₂-TFE-MVE

In a 3-neked round-bottomed flask equipped with a reflux condenser to which is connected a gas bubbler, an internal thermometer, a magnetic stirring bar and a gas inlet graphene (100 mg; 1.30 meq) are placed along with TFE-MVE-(CF₂I)₂ (EW=4303 g/eq; 5.94 g; 1.38 meq). The heterogeneous mixture is heated to 120° C. in order to melt TFE-MVE-(CF₂I)₂ and permit an efficient degassing with N₂ (2 NL/h). Degassing was continued for 60 min in order to eliminate oxygen from the reaction mixture thus avoiding radical quenching and peroxide generation. Once degassing was completed, the reaction temperature was raised to 220° C., in order to carry out homolytic —CF₂I bond cleavage. The reaction was carried out with stirring at 400 rpm in a static N2 atmosphere for 5 hours. The crude reaction mixture was therefore cooled to 20° C., and 20 ml of Galden® HT-55 was added and stirred at reflux (55° C.; 20 min) in order to eliminate unreacted TFE-MVE-(CF₂I)₂. Graphene-CF₂-TFE-MVE was recovered from the washing mixture by centrifuging at 4000 rpm at 20 C for 30 min. This washing was repeated 2 times. A 3rd washing was performed with 30 ml of C₆F₆, at reflux (80° C., 20 min) in order to eliminate Galden® HT-55 from graphene's surface along with traces of unreacted TFE-MVE-(CF₂I)₂. Graphene-CF₂-TFE-MVE was again recovered by centrifuging at 4000 rpm, 20° C. for 30 min. HI and trace amounts of 12 generated during the course of the reaction were removed by washing Graphene-CF₂-TFE-MVE with 30 ml of 10% (w/v) Na₂S₂O₃. The wet Graphene-CF₂-TFE-MVE was then washed with 20 ml THF, centrifuged at 4000 rpm, 20° C., 20 min and dried in a vacuum oven at 60° C., 0.1 mbar pressure for 2 hrs. Obtained: 0.436 g of a black, electrostatic, hydrophobic, powdery compound.

Graphene-CF₂-TFE-MVE was deposited as a 180 μm thick layer upon an inert PTFE membrane for the measurement of the Contact angle vs water: it showed a remarkable hydrophobic 135°-140° contact angle value.

The same membrane employed for the Contact Angle measurements was also used for resistivity measurements: 11.3 Ω*cm.

Covalent binding was demonstrated by solid state ¹³C, ¹⁹F-NMR as well as quantitative (internal capillary standard)¹⁹F-NMR carried out on the total HT-55 and C₆F₆ washings; by these analyses it was determined that 77% by weight of TFE-MVE with respect to the weight graphene were covalently bound to graphene, corresponding to a conversion of 5.54 eq % of starting TFE-MVE-(CF₂I)₂—.

### Example 2—Synthesis of Graphene-CF₂— TFE-MVE Starting from Graphene Obtained by Reduction of Graphene Oxide

The same procedure followed in Example 1 was carried out starting from graphene obtained by thermally treating at 240° C. graphene oxide, obtaining a material with 35 times the apparent density as the starting graphene oxide or as commercial graphene.

Covalent binding was demonstrated by solid state ¹³C-NMR, ¹⁹F-NMR as well as quantitative (internal capillary standard)¹⁹F-NMR carried out on the total HT-55 and C₆F₆ washings; by these analyses it was determined that 85% by weight of TFE-MVE with respect to graphene compound were covalently bound to graphene, corresponding to a conversion of 9.39 eq % of starting TFE-MVE-(CF₂I)₂.

The greater value of conversion to covalently bound TFE-MVE (example 2 9.39 eq % vs. 5.54 eq % of example 1) is clearly due to the greater surface area of exfoliated graphene vs. non-exfoliated, commercial graphene.

### Example 3—Synthesis of Graphene-PFPE

The same procedure followed in Example 1 was repeated but with HT-230 as the solvent and with PFPE(OCF₂I)₂ having an average MW=2026 g/mole and an average EW=1103 g/eq (synthesized as in EP 1256562). Graphene-PFPE was obtained with a conversion of 0,855 eq % of graphene's active sites (measured by ¹³C, ¹⁹F-NMR and quantitative ¹⁹F-NMR as described in example 1), corresponding to 12% by weight of covalently bound PFPE vs. graphene or 13 mg PFPE=11.8 meq PFPE for every 108 mg of graphene-PFPE.

### Example 4—Synthesis of Graphene Oxide

In a glass round-bottom flask equipped with a mechanical stirrer, a solid dispenser a reflux condenser and an internal thermometer 20 g of graphene and 10 g (117.6 mmol) of NaNO₃ were suspended in 1 L of H₂SO₄ (96% w/w) at 20° C. Vigorous (370 rpm) mechanical stirring was started and the suspension was cooled in and ice/H₂O bath to 3° C. KMnO₄ (45 g; 284 mmol; 568 meq —OH) were slowly dispensed in 60 mins. Once the addition was completed, the suspension was heated to 75° C. for 15 hours in an oil bath with 350 rpm stirring. At the end of the oxidation reaction, the suspension was cooled to 3° C. in an ice-H₂O bath and 2.6 L of distilled water were slowly added taking care not to exceed 70° C. internally during the dilution process. The diluted suspension was let stir at about 5° C. for 2 hours and then the ice-H₂O bath was removed letting the internal T rise to 20° C. H₂O₂ (320 ml at 16% w/v; 1,504 moles at 100%) was added drop-wise in 45 min and the suspension was let stir at 20° C. for 2 hours in order to ensure that all of the excess KMnO₄ was reduced. Gas (O₂) was slowly evolved and its evolution was followed in an oil bubbler. The crude reaction mixture was then uniformly poured in adequate centrifuge bottles and then centrifuged at 10000 rpm for 1.25 hours at 15° C. The pellets obtained were collected discarding the acid surnatant. The crude graphene oxide pellets were suspended in 1 L of 10% w/v aqueous HCl. The suspension was stirred for 30 min and then centrifuged at 10000 rpm for 45 min at 15° C. This acid washing/centrifuge was repeated 2 other times. The crude, acid-washed graphene oxide pellet was then suspended in distilled H₂O and filtered on a Buchner filtering funnel until the filtered H₂O was close to neutrality (pH=ca 6). The neutral, washed graphene oxide was then dried in a vacuum drying oven at 50° C., 0.1 residual P for 5 hrs. A shiny, grey lamellar solid was obtained.

A total of 20.6 g of graphene oxide was obtained.

Isolated yield=99%.
Conversion to active oxidation sites=85 mol % (measured by NMR) The modified Hummer's Oxydation of graphene to provide graphene oxide was carried out with surprisingly exceptional qualities of conversion, uniformity of oxidized surface and near absence of oxidized surface defects.

Electrical resistivity measurements indicate a value of 2812 Ω* cm.

### Example 5: Synthesis of Fluorinated Alkyl-Graphene Oxide

A glass round-bottom flask equipped with a mechanical stirrer, a solid dispenser a reflux condenser and an internal thermometer was first fluxed with N₂ in order to eliminate both O₂ and humidity from the reactor. The reactor is kept under static and slightly positive P of N₂ for the entire reaction with a rubber balloon filled with N₂ and fixed to the top the reflux condenser with a bent joint.

C₆F₁₃(CH₂)₂—OH (24.37 g; 104.16 mmol) were placed in the reactor and were diluted with anhydrous THF (100 mL). A homogeneous, colorless solution was obtained. The N₂ filled balloon was disconnected and the top of the condenser was connected to an oil bubbler. Finely ground Na(s) (1.6 g; 69.44 mmol) were then dispensed in the solution at 20° C. and let stir until complete consumption of Na. Gas (H₂) evolved, as seen from the bubbler. To ensure complete conversion the reaction was let stir at 20° C. for 6 hrs. A dark-yellow solution of alcoholate in THF was obtained. The bubbler was replaced with the N₂ filled balloon on top of the reflux condenser. A stable suspension of graphene oxide obtained in Example 4 (2.5 g=34.7 meq) in anhydrous THF (200 mL) was added drop-wise to the alcoholate in 10 min and at 20° C. The homogeneous dark suspension was then heated to 65° C. in an oil bath and let stir at 300 rpm for 8 hrs. The crude mixture was decanted and centrifuged at 10000 rpm at 15° C. for 60 min. The surnatant was kept aside. The pellet was re-suspended in fresh THF, stirred at 20° C. per 20 min and centrifuged at 10000 rpm at 15° C. for 45 min. This procedure was repeated one more time to ensure complete removal of unreacted starting fluorinated alcohol. Each surnatant was quantitatively analyzed by NMR to monitor the molar quantity of I unreacted fluorinated alcohol and to evaluate complete removal of said unreacted fluorinated alcohol. The fluorinated alkyl-graphene oxide pellet was re-suspended in H₂O at 0° C. to remove undesired NaF without hydrolyzing the covalent bonds formed between the fluorinated alkyl and graphene. The washed fluorinated alkyl-graphene was then first dried in a vacuum oven at 20° C. and at 0.1 mbar residual P for 2 hours and then at 50° C. for a further 4 hrs. 2.98 g of fluorinated alkyl-graphene oxide were obtained for a mass balance=100% w/w

By NMR analyses the presence of covalent fluorinated alkyl ester, fluorinated alkyl ether, fluorinated alkyl acetal, fluorinated alkyl eter-alcohols was shown.

The conversion to fluorinated-covalent bonds was 5.93 eq %=16.1% w/w graphene.

### Example 6: Synthesis of Fluorinated Aryl-Graphene Oxide

A glass round-bottom flask equipped with a magnetic stirrer, a solid dispenser a reflux condenser and an internal thermometer was first fluxed with N₂ in order to eliminate both O₂ and humidity from the reactor. The reactor was kept under static and slightly positive P of N₂ for the entire reaction with a rubber balloon filled with N₂ and fixed to the top the reflux condenser with a bent joint.

Graphene oxide obtained in Example 4 (0.100 g; 1.39 meq) was suspended in 8 mL of anhydrous THF along with NaNH₂ (0.18 g; 4.63 mmol). The suspension was stirred at 20° C. and 800 rpm for 1 hr. C₆F₅I (1.23 g; 4.20 mmol) were diluted in 2 mL of anhydrous THF and the homogeneous mixture was added drop-wise to the graphene oxide suspension in 10 min. The suspension was then heated to 50° C. and stirred at 900 rpm for 12 hrs. The crude suspension was poured in a centrifuge bottle and centrifuged at 4000 rpm at 20° C. for 40 min. The surnatant was kept aside and the pellet was washed with three 20 ml portions of CH₂C₁₂ to ensure complete removal of unreacted C₆F₅I. The surnatant and the washings were analyzed by quantitative NMR to calculate the unreacted C₆F₅I and to ensure its complete removal if not covalently bound to graphene. The pellet was then suspended in 20 mL H₂O at 0° C. to completely remove NaF side product. The wet pellet was the re-suspended in THF to remove residual H₂O from the fluorinated aryl-graphene and then dried in a vacuum oven at 50° C., 0.1 mbar residual P for 4 hours.

Obtained: 0.223 g of fluorinated aryl-graphene oxide with a 100 mol % conversion of electrophilic sites and 27 eq % conversion of available nucleophilic sites upon starting graphene oxide.

By NMR analyses the presence of fluorinated aryl covalently bound to a carbon atom of graphene is demonstrated.

### Example 7: Synthesis of PFPE-O—CF₂CH₂—O-graphene

A glass round-bottom flask equipped with a mechanical stirrer, a solid dispenser a reflux condenser and an internal thermometer was first fluxed with N₂ in order to eliminate both O₂ and humidity from the reactor. The reactor was kept under static and slightly positive P of N₂ for the entire reaction with a rubber balloon filled with N₂ and fixed to the top the reflux condenser with a bent joint. A bubbler replaced the N₂ filled balloon for the salification reaction.

Z-DOL-PFPE (50.82 g; 55.54 meq; 32.24 mmol) was placed in the reactor under N₂ and finely ground Na (1.27 g; 55.22 mmol) was dispensed upon said Z-DOL-PFPE at 20° C. forming a dishomogeneous solution. To aid the dispersion 30 mL of anhydrous THF are added. Gas evolves as evidenced from the bubbler as well as observing the surface of the Na flakes. The suspension was vigorously stirred overnight obtaining a yellow, viscous liquid (Z-DOL“ate”). Residual, unreacted Na was removed by decanting the solution. The bubbler was replaced by the N₂ filled balloon. Graphene oxide obtained from Example 4 (4.00 g; 23.8 meq electrophilic sites) were suspended in 600 mL of anhydrous THF and stirred at 300 rpm at 65° C. for 8 hrs.

The crude PFPE-O—CF₂CH₂—O-graphene solution was placed in a centrifuge bottle and centrifuged at 10000 rpm at 15° C. for 80 min. The pellet was re-suspended in 300 mL hexafluoroxylene, stirred at 20° C. for 1 hr, centrifuged at 10000 rpm, 15° C. for 60 min. The pellet was then re-suspended in the fluorinated neutral fluid HT-55, stirred for 60 min at 20° C. and centrifuged at 10000 rpm, 15° C. for 60 min. These washings are necessary to remove all of the unreacted PFPE from the graphene surface. The solvents were analyzed by quantitative NMR in order to determine the unreacted Z-DOL as well as to determine its complete removal if not covalently bound to graphene.

Obtained: 5.58 g of very heavy, non-electrostatic flakes. Mass balance recovery=99%.

Conversion to covalently bound PFPE-CH₂CF₂—O— to graphene=6.85 eq %=2.94 wt % vs Z-DOL-PFPE and 26% by weight vs starting graphene oxide.

### Example 8: Synthesis of PVDF-HEA-Graphene Oxide

A glass round-bottom flask equipped with a magnetic stirrer, a solid dispenser a reflux condenser and an internal thermometer is first fluxed with N₂ in order to eliminate both O₂ and humidity from the reactor. The reactor is kept under static and slightly positive P of N₂ for the entire reaction with a rubber balloon filled with N₂ and fixed to the top the reflux condenser with a bent joint. A bubbler replaced the N₂ filled balloon for the salification reaction.

PVDF-HEA (0.971 g, 0.103 meq HEA) was dissolved in anhydrous THF (15 mL) the solution was stirred at 800 rpm and Na (9.91 mg; 0.43 mmol) was dispensed in the solution. The solution was then heated to 50° C. for 4 hrs. Slow evolution of H₂ was observed on the surface of the Na flakes. Once the salification was over (consumption of Na) graphene oxide obtained in Example 4 (100 mg; 1.39 meq) was suspended in 15 mL of anhydrous THF and the stable suspension was added dropwise to the PVDF-HEA alcoholate solution. The stable suspension was stirred at 1000 rpm and kept at 65° C. for 8 hrs. The crude PVDF-HEA-Graphene suspension was cooled to 20° C. and poured in DMF (70 mL). The suspension was stirred at 20° C. for 20 min and then centrifuged at 4000 rpm, 20° C. for 45 min. The surnatant was separated and the pellet was re-suspended in fresh DMF (70 mL) repeating the washing procedure again. The surnatant was separated and the pellet was suspended in H₂O (70 mL), stirred at 20° C. for 1 hour and then centrifuged at 10000 rpm, 15° C. for 60 min. The pellet obtained was rewashed/centrifuged in the same manner one more time. The pellet was the washed one last time with 70 mL H₂O filtering with a Buchner funnel. The solid was then suspended in dry THF at 20° C. and filtered in Buchner funnel to remove the interstitial H₂O. The solid was then dried in vacuum oven at 50° C., 0.1 mbar residual P for 4 hrs.

The surnatants were analyzed by quantitative NMR evaluating the non-converted PVDF-HEA ensuring its complete removal if not covalently bound to graphene.

Obtained: 140 mg of opaque grey, heavy powder.

It was determined that 40 mg of staring PVDF-HEA was covalently bound to graphene representing 2.86 peq of PVDF-HEA=0.205 eq % vs available reactive site on starting graphite oxide.

PVDF present in 28.5 wt % vs graphite.

### Example 9: Reduction of Fluorinated Graphene Oxides (FGO) to Fluorinated Graphenes (FG)

The compounds obtained in examples 5, 6, 7 and 8 were submitted to a thermal treatment according to the following protocol:

2 hours at 150° C.;
0.5 hours at 200° C.; and
0.5 hours at 230° C.

Resistivity of the fluorinated graphene oxide compounds obtained in examples 5 to 8 and of the corresponding fluorinated graphene compounds obtained after thermal treatment was measured.

ρᵥ (Ohm*cm)

| | | After thermal treatment |
|---|---|---|
| Example 5 | 2364 | 79 |
| Example 6 | 352 | 28 |
| Example 7 | 4492 | 20 |
| Example 8 | 1119 | 39 |

The results in Table 1 show that after thermal treatment the resistivity of the fluorinated graphene compounds is reduced, thus confirming the re-aromatization of the graphene structure by reduction of the residual oxygen-containing reactive groups of the graphene oxide.

1. A fluorinated grapheme (FG) derivative comprising:
a graphene having a plurality of inner and peripheral carbon atoms; and
at least one fluorinated moiety (R), wherein said fluorinated moiety (R) is selected from the group consisting of fluorinated alkyl, fluorinated heteroalkyl, fluorinated aryl and fluorinated polymeric or oligomeric moieties;
wherein the at least one fluorinated moiety (R) is covalently bound to at least one inner or peripheral carbon atom of the graphene via a linking group (L),
wherein said linking group (L) is a bond or is selected from the group consisting of *—O—**, *—O—C(O)—** and *—C(O)—O—**,
wherein the symbol * indicates the bond with graphene and the symbol ** indicates the bond with the fluorinated moiety (R);
with the proviso that when the at least one fluorinated moiety (R) is a fluorinated alkyl, the linking group (L) is not a bond.

2. The fluorinated graphene (FG) derivative according to claim 1 wherein the at least one fluorinated moiety (R) is a fluorinated polymeric or oligomeric moiety, and the linking group (L) is a bond, *—O—** or *—O—C(O)—**.

3. The fluorinated graphene (FG) derivative according to claim 1 wherein the fluorinated polymeric or oligomeric moiety comprises recurring units derived from the polymerization of at least one ethylenically unsaturated fluorinated monomer.

4. The fluorinated graphene (FG) derivative according to claim 3 wherein the ethylenically unsaturated fluorinated monomer is selected from the group consisting of:
C₂-C₈ fluoro- and/or perfluoroolefins;
perfluoroalkylethylenes of formula CH₂═CH—R_{f0}, wherein R_{f0} is a C₁-C₆ perfluoroalkyl group;
chloro- and/or bromo- and/or iodo-C₂-C₆ fluoroolefins;
(per)fluoroalkylvinylethers of formula CF₂═CFOR_{f1}, wherein R_{f1} is a C₁-C₆ fluoro- or perfluoroalkyl group;
(per)fluoro-oxyalkylvinylethers of formula CF₂═CFOX₀, wherein X₀ is a C₁-C₁₂ oxyalkyl group or a C₁-C₁₂ (per)fluorooxyalkyl group having one or more ether groups;
fluoroalkyl-methoxy-vinylethers of formula CF₂═CFOCF₂OR_{f2}, wherein R_{f} is a C₁-C₆ fluoro- or perfluoroalkyl group or a C₁-C₆ (per)fluorooxyalkyl group having one or more ether groups; and
fluorodioxoles of formula: 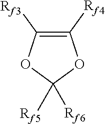
wherein each of R_{f3}, R_{f4}, R_{f5} and R_{f6}, equal to or different from each other, is independently a fluorine atom, a C₁-C₆ fluoro- or per(halo)fluoroalkyl group, optionally comprising one or more oxygen atoms.

5. The fluorinated graphene (FG) derivative according to claim 1 wherein the fluorinated polymeric or oligomeric moiety further comprises recurring units derived from at least one hydrophilic (meth)acrylic monomer (MA) of formula (I): 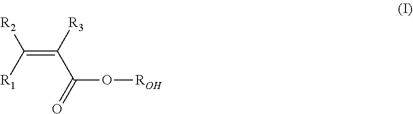
wherein each of R₁, R₂, R₃, equal or different from each other, is independently a hydrogen atom or a C₁-C₃ hydrocarbon group, and R_{OH} is a hydroxyl group or a C₁-C₅ hydrocarbon moiety comprising at least one hydroxyl group.

6. The fluorinated graphene (FG) derivative according to claim 5 wherein the fluorinated polymeric or oligomeric moiety comprises recurring units derived from VDF and recurring units deriving from a hydrophilic (meth)acrylic monomer (MA) wherein R_{OH} is a C₁-C₅ hydrocarbon moiety comprising at least one hydroxyl group.

7. The fluorinated graphene (FG) derivative according to claim 1 wherein the fluorinated polymeric or oligomeric moiety is a fluorinated polyether comprising at least one (per)fluoropolyether (PFPE) chain (R_{pf}).

8. The fluorinated graphene (FG) derivative according to claim 7 wherein chain (R_{pf}) is a chain of formula —(CF X₁)ₐO(R_{f})(CF X₂)_{b}—, wherein a and b, equal or different from each other, are equal to or greater than 1;
X₁ and X₂, equal or different from each other, are —F or —CF₃,
provided that when a and/or b are higher than 1, X₁ and X₂ are —F; and
(R_{f}) comprises repeating units being independently selected from the group consisting of:
(i) —CF X₁O—, wherein X₁ is F or CF₃;
(ii) —CF X₁CF X₁O—, wherein X₁, equal or different at each occurrence, is F or CF₃, with the proviso that at least one of X₁ is —F;
(iii) —CF₂CF₂CW₂O—, wherein each of W, equal or different from each other, are F, Cl, or H;
(iv) —CF₂CF₂CF₂CF₂O—; and
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CF X₁O—, —CF₂CF X₁O—, —CF₂CF₂CF₂O—, —CF₂CF₂CF₂CF₂O—, with each of each of X₁ being independently F or CF₃ and T being a C₁-C₃ perfluoroalkyl group.

9. The fluorinated graphene (FG) derivative according to claim 8 wherein chain (R_{f}) complies with formula (R_{f}-III):
—[(CF₂CF₂O)ₐ₁(CF₂O)ₐ₂]— (R_{f}-III)
wherein:
a1 and a2 are integers greater than 0 such that the number average molecular weight is between 400 and 10,000, with the ratio a1/a2 being comprised between 0.1 and 10.

10. The fluorinated graphene (FG) derivative according to claim 1 wherein the fluorinated alkyl is a C₄-C₁₀ fluorinated alkyl.

11. A method for preparing at least one fluorinated grapheme (FG) derivative according to claim 1, said method comprising:
reacting at least one inner or peripheral carbon atom of at least one graphene having a plurality of inner and peripheral carbon atoms with at least one fluorinated compound (FC) of formula R—X,
wherein R is a fluorinated moiety selected from the group consisting of fluorinated alkyl, fluorinated heteroalkyl, fluorinated aryl and fluorinated polymeric or oligomeric moieties, and X is a halogen atom.

12. The method according to claim 11 wherein:
R is a fluorinated alkyl; or
R is a fluorinated aryl; or
R is a fluorinated polymeric or oligomeric moiety selected from:
a partially fluorinated fluoropolymer comprising recurring units derived from the polymerization of at least one ethylenically unsaturated fluorinated monomer; or
a fluorinated polyether comprising at least one (per)fluoropolyether (PFPE) chain (R_{pf})
X is an iodine atom.

13. A method for preparing at least one fluorinated graphene (FG) derivative according to claim 1, said method comprising:
reacting at least one inner or peripheral carbon atom bearing an oxygen-containing reactive group, wherein said carbon atom is on a graphene oxide that includes a plurality of inner and peripheral carbon atoms wherein at least one inner or peripheral carbon atom bears an oxygen-containing reactive group, with at least one fluorinated compound (FC) of formula R—X′ to obtain a fluorinated graphene oxide (FGO),
wherein R is a fluorinated moiety selected from the group consisting of fluorinated alkyl, fluorinated heteroalkyl, fluorinated aryl and fluorinated polymeric or oligomeric moieties, and X′ is a group selected from a hydroxyl group, an alcoxide group, a magnesium halide group MgHal, wherein Hal denotes a halogen atom, a sulfonated ester group or an acyl halide group; and
reducing residual oxygen-containing reactive groups of the graphene oxide.

14. The method according to claim 13 wherein R is a fluorinated moiety selected from the group consisting of fluorinated alkyl, fluorinated heteroalkyl, fluorinated aryl and fluorinated polymeric or oligomeric moieties; and
X′ is a hydroxyl group, an alcoxide group, a magnesium halide group MgHal, wherein Hal denotes a halogen atom, a sulfonated ester group or an acyl halide group.

15. A fluorinated graphene oxide derivative (FGO) comprising:
a graphene oxide having a plurality of inner and peripheral carbon atoms; and
at least one fluorinated moiety (R), wherein said fluorinated moiety (R) is selected from the group consisting of fluorinated alkyl, fluorinated heteroalkyl, fluorinated aryl and fluorinated polymeric or oligomeric moieties;
wherein the at least one fluorinated moiety (R) is covalently bound to at least one peripheral carbon atom of the graphene oxide via a linking group (L),
wherein said linking group (L) is a bond or is selected from the group consisting of *—O—**, *—O—C(O)—** and *—C(O)—O—**,
wherein the symbol * indicates the bond with graphene and the symbol ** indicates the bond with the fluorinated moiety (R),
wherein the fluorinated polymeric or oligomeric moiety comprises recurring units derived from the polymerization of at least one ethylenically unsaturated fluorinated monomer or is a fluorinated polyether comprising at least one (per)fluoropolyether (PFPE) chain (Rpf).

16. The fluorinated graphene (FG) derivative according to claim 6 wherein the fluorinated polymeric or oligomeric moiety consists of recurring units derived from VDF and recurring units deriving from a hydrophilic (meth)acrylic monomer (MA) wherein R_{OH} is a C₁-C₅ hydrocarbon moiety comprising at least one hydroxyl group.

17. The fluorinated graphene (FG) derivative according to claim 8 wherein:
a and b, equal or different from each other, are from 1 to 3;
X₁ and X₂, equal or different from each other, are —F or —CF₃, provided that when a and/or b are higher than 1, X₁ and X₂ are —F; and
(R_{f}) consists of repeating units being independently selected from the group consisting of:
(i) —CF X₁O—, wherein X₁ is F or CF₃;
(ii) —CF X₁CF X₁O—, wherein X₁, equal or different at each occurrence, is F or CF₃, with the proviso that at least one of X₁ is —F;
(iii) —CF₂CF₂CW₂O—, wherein each of W, equal or different from each other, are F, Cl, or H;
(iv) —CF₂CF₂CF₂CF₂O—; and
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CF X₁O—, —CF₂CF X₁O—, —CF₂CF₂CF₂O—, —CF₂CF₂CF₂CF₂O—, with each of each of X₁ being independently F or CF₃ and T being a C₁-C₃ perfluoroalkyl group.

18. The fluorinated graphene (FG) derivative according to claim 10 wherein the fluorinated alkyl is selected from the group consisting of (CF₃)₃C—, C₆F₁₃—, C₆F₁₃(CH₂)₂— and C₄F₉(CH₂)₂—.

19. The method according to claim 12 wherein:
R is a C₄-C₁₀ fluorinated alkyl selected from the group consisting of C₆F₃(CH₂)₂—, C₆F₁₃—, C₄F₉(CH₂)₂— and I—C₆F₁₂—; or
R is a partially or fully fluorinated phenyl; or
R is a partially fluorinated fluoropolymer comprising recurring units derived from the polymerization of at least one ethylenically unsaturated fluorinated monomer selected from the group consisting of VDF, TFE, MVE, MOVE3 and HFP.

20. The method according to claim 13, wherein the oxygen-containing reactive group is selected from a hydroxyl group, an epoxide group, a carboxyl group or a ketone group.
